(19) United States
(12) Patent Application Publication
(10) Pub. No.: US 2020/0304209 A1
(43) Pub. Date: Sep. 24, 2020

(54) Transceiving With a Predetermined Frequency Spacing

(71) Applicant: Huawei Technologies Co., Ltd., Shenzhen (CN)

(72) Inventors: Xiang Liu, Marlboro, NJ (US); Ning Cheng, Basking Ridge, NJ (US); Frank Effenberger, Frisco, TX (US)

(21) Appl. No.: 16/898,860

(22) Filed: Jun. 11, 2020

Related U.S. Application Data
(63) Continuation of application No. PCT/CN2019/099092, filed on Aug. 2, 2019.
(60) Provisional application No. 62/739,997, filed on Oct. 2, 2018.

(51) Int. Cl. H04B 10/50; H04B 10/61; H04B 10/524

(52) U.S. Cl. CPC H04B 10/506; H04B 10/524; H04B 10/6164; H04B 10/504

(57) ABSTRACT

An apparatus comprises: a receiver; a transmitter; a laser device coupled to the receiver and the transmitter and comprising: a first laser configured to provide to the receiver a first optical wave centered at a first frequency, and a second laser configured to provide to the transmitter a second optical wave centered at a second frequency, the first frequency and the second frequency have a predetermined frequency spacing; and a processor coupled to the receiver, the transmitter, and the laser device, with the processor configured to control the first laser and the second laser to maintain the predetermined frequency spacing.

### CROSS-REFERENCE TO RELATED APPLICATIONS

This is a continuation of Int'l Patent App. No. PCT/CN2019/099092 filed on Aug. 2, 2019 by Huawei Technologies Co., Ltd. and titled “Transceiving With a Predetermined Frequency Spacing,” which claims priority to U.S. Prov. Patent App. No. 62/739,997 filed on Oct. 2, 2018 by Futurewei Technologies, Inc. and titled “Transceiving With a Predetermined Frequency Spacing,” both of which are incorporated by reference.

### TECHNICAL FIELD

The disclosed embodiments relate to optical networks in general and transceiving in optical networks in particular.

### BACKGROUND

Optical networks are networks that use light waves, or optical signals, to carry data. Light sources such as lasers and LEDs generate the optical signals, modulators modulate the optical signals with the data to generate modulated optical signals, and various components transmit, propagate, amplify, receive, and process the modulated optical signals. Optical networks may implement WDM or other forms of multiplexing to achieve high bandwidths.

### SUMMARY

In an embodiment, an apparatus comprises: a receiver; a transmitter; a laser device coupled to the receiver and the transmitter and comprising: a first laser configured to provide to the receiver a first optical wave centered at a first frequency, and a second laser configured to provide to the transmitter a second optical wave centered at a second frequency, the first frequency and the second frequency have a predetermined frequency spacing; and a processor coupled to the receiver, the transmitter, and the laser device, with the processor configured to control the first laser and the second laser to maintain the predetermined frequency spacing.

In any of the preceding embodiments, the first laser is a local oscillator (LO) laser, wherein the first optical wave is an LO wave.

In any of the preceding embodiments, the receiver is configured to: receive a downstream optical signal centered at a third frequency; receive the LO wave from the first laser; determine a frequency offset between the first frequency and the third frequency; and provide to the processor a feedback signal based on the frequency offset.

In any of the preceding embodiments, the receiver is a coherent optical receiver.

In any of the preceding embodiments, the second laser is a carrier laser, and the second optical wave is a carrier wave.

In any of the preceding embodiments, the transmitter is configured to: receive the carrier wave from the second laser; receive a data signal from the processor; modulate the carrier wave using the data signal to create an upstream optical signal; and provide the upstream optical signal.

In any of the preceding embodiments, the transmitter is further configured to further modulate the carrier wave using OOK modulation.

In any of the preceding embodiments, the transmitter is further configured to further modulate the carrier wave using PAM.

In any of the preceding embodiments, the apparatus further comprises a splitter coupled to the receiver and the transmitter and configured to: provide the downstream optical signal to the receiver; and receive the upstream optical signal from the transmitter.

In any of the preceding embodiments, the apparatus further comprises a port coupled to the splitter and configured to: receive the downstream optical signal from a second apparatus over an optical fiber, provide the downstream optical signal to the splitter, receive the upstream optical signal from the splitter, and transmit the upstream optical signal towards the second apparatus over the optical fiber.

In any of the preceding embodiments, the port is further configured to provide bidirectional communication over the optical fiber.

In any of the preceding embodiments, the port is the only communications port in the apparatus.

In any of the preceding embodiments, the laser device further comprises a controller coupled to the processor and configured to: receive a control signal from the processor; and perform a control action on both the first laser and the second laser in response to the control signal.

In any of the preceding embodiments, the controller is a heater, wherein the control action is heating.

In any of the preceding embodiments, the controller is a TEC, wherein the control action is cooling.

In any of the preceding embodiments, the controller is a bias current controller, wherein the control action is a bias current.

In any of the preceding embodiments, the predetermined frequency spacing is set by a design of the laser device.

In any of the preceding embodiments, the processor is further configured to further maintain the predetermined frequency spacing independent of an ambient temperature.

In any of the preceding embodiments, the predetermined frequency spacing is about 100 GHz.

In any of the preceding embodiments, the apparatus is an ONU.

In any of the preceding embodiments, the apparatus is part of a PTMP network.

In an embodiment, a method comprises: providing, by a first laser of a laser device and to a receiver, a first optical wave centered at a first frequency; providing, by a second laser of the laser device and to a transmitter, a second optical wave centered at a second frequency, the first frequency and the second frequency have a predetermined frequency spacing; and maintaining, by a processor coupled to the laser device, the predetermined frequency spacing.

In any of the preceding embodiments, the first optical wave is an LO wave.

In any of the preceding embodiments, the method further comprises: receiving a downstream optical signal centered at a third frequency; determining a frequency offset between the first frequency and the third frequency; and providing to the processor a feedback signal based on the frequency offset.

In any of the preceding embodiments, the second optical wave is a carrier wave.

In any of the preceding embodiments, the method further comprises: receiving a data signal from the processor; and modulating the carrier wave using the data signal to create an upstream optical signal.

In any of the preceding embodiments, the method further comprises further modulating the carrier wave using OOK modulation.

In any of the preceding embodiments, the method further comprises further modulating the carrier wave using PAM.

In any of the preceding embodiments, the method further comprises: receiving a control signal from the processor; and performing a control action on both the first laser and the second laser in response to the control signal.

In any of the preceding embodiments, the control action is heating.

In any of the preceding embodiments, the control action is cooling.

In any of the preceding embodiments, the control action is a bias current.

In any of the preceding embodiments, the predetermined frequency spacing is set by a design of the laser device.

In any of the preceding embodiments, the method further comprises further maintaining the predetermined frequency spacing independent of an ambient temperature.

In any of the preceding embodiments, the predetermined frequency spacing is about 100 GHz.

In an embodiment, an ONU comprises: a receiver; a laser device coupled to the receiver and comprising: a first laser configured to provide to the receiver a first optical wave centered at a first frequency, and a second laser configured to provide an upstream optical signal centered at a second frequency, the first frequency and the second frequency have a predetermined frequency spacing, and the second laser is a DML; and a processor coupled to the receiver and the laser device, with the processor configured to control the first laser and the second laser to maintain the predetermined frequency spacing.

In any of the preceding embodiments, the first laser is an LO, wherein the first optical wave is an LO wave.

In any of the preceding embodiments, the receiver is configured to: receive a downstream optical signal centered at a third frequency; receive the LO wave from the first laser; determine a frequency offset between the first frequency and the third frequency; and provide to the processor a feedback signal based on the frequency offset.

In any of the preceding embodiments, the receiver is a coherent optical receiver.

In any of the preceding embodiments, the second laser is further configured to: receive a data signal from the processor; and generate the upstream optical signal through direct modulation of the data signal.

In any of the preceding embodiments, the second laser is further configured to further generate the upstream optical signal through OOK modulation.

In any of the preceding embodiments, the second laser is further configured to further generate the upstream optical signal through PAM.

In any of the preceding embodiments, the ONU further comprises a splitter coupled to the receiver and the second laser and configured to: provide the downstream optical signal to the receiver; and receive the upstream optical signal from the second laser.

In any of the preceding embodiments, the ONU further comprises a port coupled to the splitter and configured to: receive the downstream optical signal from an OLT over an optical fiber, provide the downstream optical signal to the splitter, receive the upstream optical signal from the splitter, and transmit the upstream optical signal towards the OLT over the optical fiber.

In any of the preceding embodiments, the port is further configured to provide bidirectional communication over the optical fiber.

In any of the preceding embodiments, the port is the only communications port in the apparatus.

In any of the preceding embodiments, the laser device further comprises a controller coupled to the processor and configured to: receive a control signal from the processor; and perform a control action on both the first laser and the second laser in response to the control signal.

In any of the preceding embodiments, the controller is a heater, wherein the control action is heating.

In any of the preceding embodiments, the controller is a TEC, wherein the control action is cooling.

In any of the preceding embodiments, the controller is a bias current controller, wherein the control action is a bias current.

In any of the preceding embodiments, the predetermined frequency spacing is set by a design of the laser device.

In any of the preceding embodiments, the processor is further configured to further maintain the predetermined frequency spacing independent of an ambient temperature.

In any of the preceding embodiments, the predetermined frequency spacing is about 100 GHz.

In any of the preceding embodiments, the ONU is part of a PTMP network.

Any of the above embodiments may be combined with any of the other above embodiments to create a new embodiment. These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of a network.

FIG. 2 is a schematic diagram of an ONU according to an embodiment of the disclosure.

FIG. 3 is a schematic diagram of an ONU according to another embodiment of the disclosure.

FIG. 4A is a graph of a channel scheme according to an embodiment of the disclosure.

FIG. 4B is a graph of a channel scheme according to another embodiment of the disclosure.

FIG. 5 is a flowchart illustrating a method of implementing transceiving with a predetermined frequency spacing according to an embodiment of the disclosure.

FIG. 6 is a schematic diagram of an apparatus according to an embodiment of the disclosure.

### DETAILED DESCRIPTION

It should be understood at the outset that, although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

The following abbreviations apply:

ADC: analog-to-digital conver(sion,ter)

ASIC: application-specific integrated circuit

BNG: broadband network gateway

CPU: central processing unit

DFB: distributed feedback

DML: directly-modulated laser

DSP: digital signal processor

EBE: electrical bandwidth efficiency

EO: electrical-to-optical

FPGA: field-programmable gate array

GBd: gigabaud

Gb/s: gigabit(s) per second

GHz: gigahertz

GS/s: gigasamples(s) per second

Hz: hertz

LED: light-emitting diode

LO: local oscillator

MHZ: megahertz

m/s: meter(s) per second

NRZ: non-return-to-zero

OADM: optical add-drop multiplexer

ODN: optical distribution network

OE: optical-to-electrical

ONU: optical network unit

OOK: on-off keying

OSE: optical spectral efficiency

PAM: pulse-amplitude modulation

PAM-4: 4-level PAM

PDM: polarization-division multiplexing

PTMP: point-to-multipoint

QPSK: quadrature phase-shift keying

RAM: random-access memory

RF: radio frequency

ROM: read-only memory

RX: receiver unit

SRAM: static RAM

TCAM: ternary content-addressable memory

TEC: thermoelectric cooler

TX: transmitter unit

WDM: wavelength-division multiplexing

16-QAM: 16-level quadrature amplitude modulation.

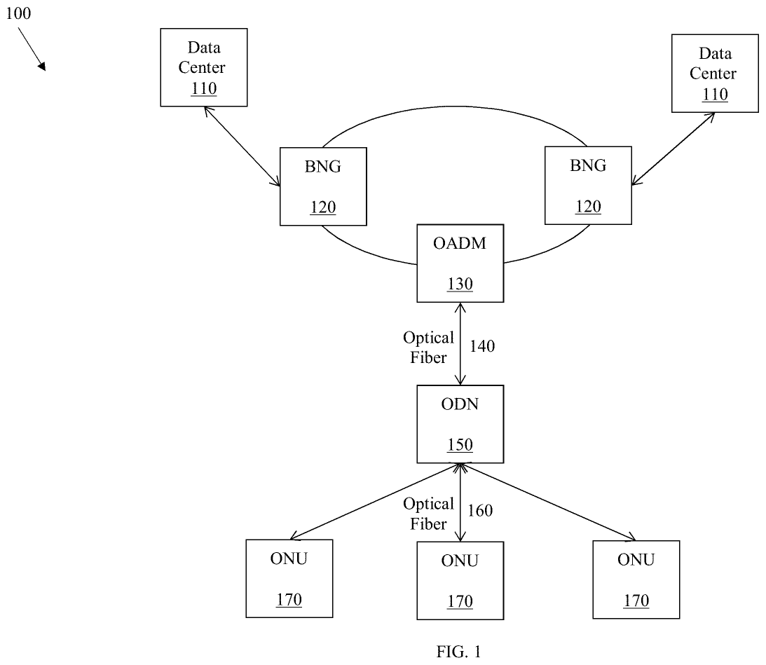

FIG. 1 is a schematic diagram of a network 100. The network 100 comprises data centers 110, BNGs 120, an OADM 130, an optical fiber 140, an ODN 150, optical fibers 160, and ONUs 170. The data centers 110 are facilities that house computer systems, communications systems, and storage systems for communicating data with the BNGs 120. The BNGs 120 provide access points for the OADM 130 to communicate with the data centers 110. The OADM 130 dynamically implements WDM by adding and dropping wavelength channels. The OADM 130 communicates with the ONUs 170 through the optical fiber 140, the ODN 150, and the optical fibers 160 and using those wavelength channels. The ODN 150 comprises passive optical components such as couplers, splitters, and distributors in order to facilitate that communication. The ONUs 170 are endpoints associated with customers. Together, the OADM 130, the optical fiber 140, the ODN 150, and the optical fibers 160 form a PTMP network.

The ONUs 170 receive downstream optical signals from the ODN 150 at first wavelengths, transmit upstream optical signals to the ODN 150 at second wavelengths, and may lock the second wavelengths to the first wavelengths using heterodyne detection or homodyne detection. However, heterodyne detection and homodyne detection suffer from low OSE, difficulty in separating downstream channels from upstream channels, and low EBE.

Disclosed herein are embodiments for transceiving with a predetermined frequency spacing. An ONU provides bidirectional communication, which in this context means both downstream reception and upstream transmission, through a single port and over a single optical fiber. The ONU transmits upstream optical signals in sub-channels that are well aligned in frequency, meaning with minimal spectral gap between adjacent sub-channels, thus increasing an OSE. An increased OSE allows for a reduced receiver electronic bandwidth needed to simultaneously detect and recover the upstream optical signals, thus increasing an EBE. The ONU comprises a laser (such as a laser device or laser chip) that provides an LO signal for a receiver and a laser that provides a carrier signal for a transmitter. The laser implements a predetermined frequency spacing between a frequency of the LO signal, and thus a downstream optical signal, and a frequency of the carrier signal, and thus an upstream optical signal. The predetermined frequency allows for easier separation of the downstream optical signal and the upstream optical signal and also reduces or eliminates crosstalk between the downstream optical signal and the upstream optical signal. In addition, the laser maintains the predetermined frequency spacing by adjusting the frequency of the LO signal and the frequency of the carrier signal by the same amount, so the predetermined frequency spacing is insensitive to, or independent of, an ambient temperature. Though ONUs are discussed, the embodiments apply to any apparatus implementing a transceiver in an optical network.

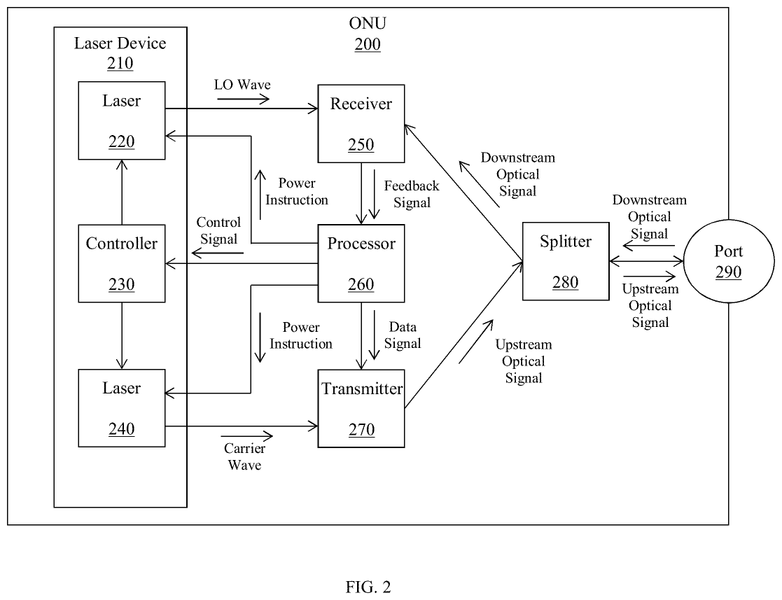

FIG. 2 is a schematic diagram of an ONU 200 according to an embodiment of the disclosure. The ONU 200 implements the ONUs 170 in FIG. 1 in some embodiments. The ONU 200 comprises a laser device 210, a receiver 250, a processor 260, a transmitter 270, a splitter 280, and a port 290. In some embodiments, the laser device 210 comprises a laser chip or laser sub-assembly, for example. The receiver 250 is communicatively coupled to the laser device 210, the processor 260, and the splitter 280 in the embodiment shown. The transmitter 270 is similarly communicatively coupled to the laser device 210, the processor 260, and the splitter 280. The splitter 280 is further communicatively coupled to the port 290.

The laser device 210 may also be referred to as a laser substrate or a laser semiconductor. The laser device 210 comprises a laser 220, a controller 230, and a laser 240. The laser 220 may be referred to as a receiver laser, an LO, or an optical LO, and the laser 240 may be referred to as a transmitter laser or a carrier laser. The lasers 220, 240 may be distributed feedback (DFB) lasers. The laser 220 generates and emits an LO wave centered at a first frequency, and the laser 240 generates and emits a carrier wave centered at a second frequency. The LO wave and the carrier wave are optical waves. The controller 230 is a temperature controller in the form of a heater or a TEC, a bias current controller, or another suitable controller. A manufacturer of the laser device 210 designs the first frequency and the second frequency as defaults and therefore designs a predetermined frequency spacing between the first frequency and the second frequency. For instance, the lasers 220, 240 are DFB lasers and the manufacturer designs a first grating reflector for the laser 220 to have a reflection band center at the first frequency and a second grating reflector for the laser 240 to have a reflection band center at the second frequency.

The receiver 250 may be referred to as a coherent optical receiver. Together, the receiver 250 and the transmitter 270 form a transceiver to implement transceiving. The port 290 is a communications port and provides bidirectional communication via an optical fiber or such as one of the optical fibers 160 or via another optical medium. Though the ONU 200 may further include a power port (not shown), the port 290 may be the only communications port in the ONU 200.

In a downstream direction, the port 290 receives a downstream optical signal from the OADM 130 and through the optical fiber 140, the ODN 150, and an optical fiber 160 in FIG. 1. The port 290 provides the downstream optical signal to the splitter 280. The splitter 280 provides the downstream optical signal to the receiver 250. Meanwhile, in response to a power instruction from the processor 260, the laser 220 powers on, generates an LO wave, and provides the LO wave to the receiver 250. The LO wave may also be referred to as an optical LO wave.

The receiver 250 receives the downstream optical signal from the splitter 280 and the LO wave from the laser 220, beats together the downstream optical signal and the LO wave to create a beat signal, and determines a frequency of the beat signal. The frequency of the beat signal is the same or about the same as a frequency offset, or frequency difference, between a frequency of the downstream optical signal and a frequency of the LO wave. The receiver 250 provides to the processor 260 a feedback signal based on the frequency offset. The feedback signal may indicate the frequency offset.

In response to the feedback signal, the processor 260 generates a control signal to reduce the frequency offset and provides the control signal to the controller 230. The controller 230 responds to the control signal by performing a control action. For instance, the controller 230 is a heater and the control action is heating up, which heats up the laser 220 and shifts the frequency of the LO wave. Alternatively, the controller 230 is a TEC and the control action is cooling or the controller 230 is a bias controller current controller and the control action is a bias current. The receiver 250 continues providing feedback signals to the processor 260 and the processor 260 continues providing control signals to the controller 230 in a feedback loop until the receiver 250 locks the LO wave to the downstream optical signal, which occurs when the frequency offset is less than a threshold, for instance about 100 MHz. After the locking occurs, the receiver 250 performs coherent detection of the downstream optical signal using the LO wave.

In an upstream direction, in response to a power instruction from the processor 260, the laser 240 powers on, generates a carrier wave, and provides the carrier wave to the transmitter 270. The transmitter 270 receives the carrier wave from the laser 240, receives a data signal from the processor 260, modulates the carrier wave using the data signal to create an upstream optical signal, and provides the upstream optical signal to the splitter 280. The transmitter 270 uses OOK modulation, PAM, or another suitable modulation format. The splitter 280 provides the upstream optical signal to the port 290. The port 290 transmits the upstream optical signal towards the OADM 130 and through an optical fiber 160, the ODN 150, and the optical fiber 140 in FIG. 1.

As mentioned above, the manufacturer of the laser device 210 designs the predetermined frequency spacing between the first frequency of the LO wave and the second frequency of the carrier wave. Because the LO wave is locked to the downstream optical signal, like the LO wave, the downstream optical signal is also centered at the first frequency. Because the upstream optical signal is based on the carrier wave, like the carrier wave, the upstream optical signal is also centered at the second frequency. Thus, like the LO wave and the carrier wave, the downstream optical signal and the upstream optical signal also have the predetermined frequency spacing. The processor 260 and the controller 230 maintain the predetermined frequency spacing. Specifically, the control signal from the processor 260 to the controller 230 and the resulting control action of the controller 230 affect both the laser 220 and the laser 240 the same or substantially the same so that the first frequency and the second frequency shift by the same or substantially the same amount. The predetermined frequency spacing is therefore independent of an ambient temperature of the laser device 210 specifically, and the ONU 200 generally.

As an example, the predetermined frequency spacing is 100 GHz, the downstream optical signal is centered at a first frequency of 0 GHz, and the upstream optical signal is centered at a second frequency of 100 GHz. Though frequencies are described, one may determine a corresponding wavelength based on the following relationship:

λ=c/ν (1)

λ is wavelength, c is the speed of light, and ν is frequency. c is approximately 3×10⁸ m/s in a vacuum.

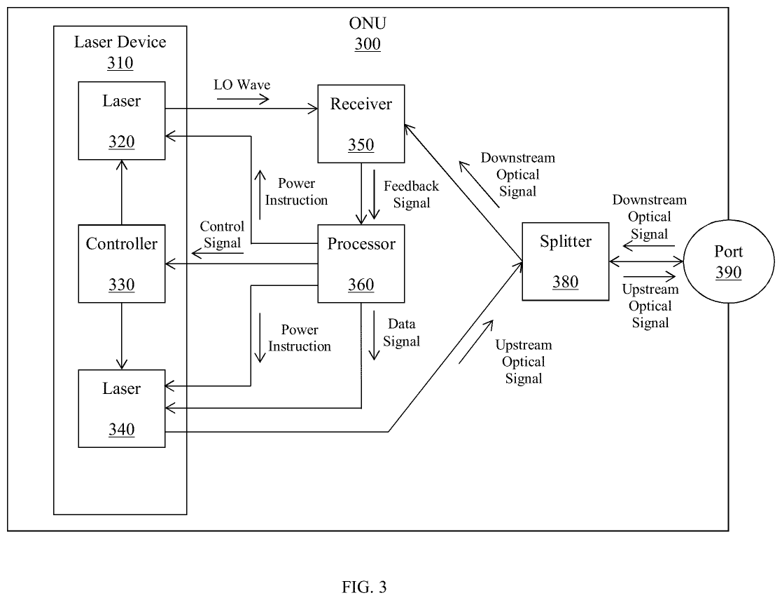

FIG. 3 is a schematic diagram of an ONU 300 according to another embodiment of the disclosure. The ONU 300 is similar to the ONU 200. Specifically, like the ONU 200, the ONU 300 comprises a laser device 310, a receiver 350, a processor 360, a splitter 380, and a port 390. Like the laser device 210 in the ONU 200, the laser device 310 comprises a laser 320, a controller 330, and a laser 340. However, unlike the ONU 200, which comprises the transmitter 270, the ONU 300 does not comprise a transmitter. Instead, the laser 340 may be referred to as a transmitter laser or a DML. In addition, the laser 340 receives a data signal from the processor 360, generates an upstream optical signal through direct modulation of the data signal, and provides the upstream optical signal directly to the splitter 380.

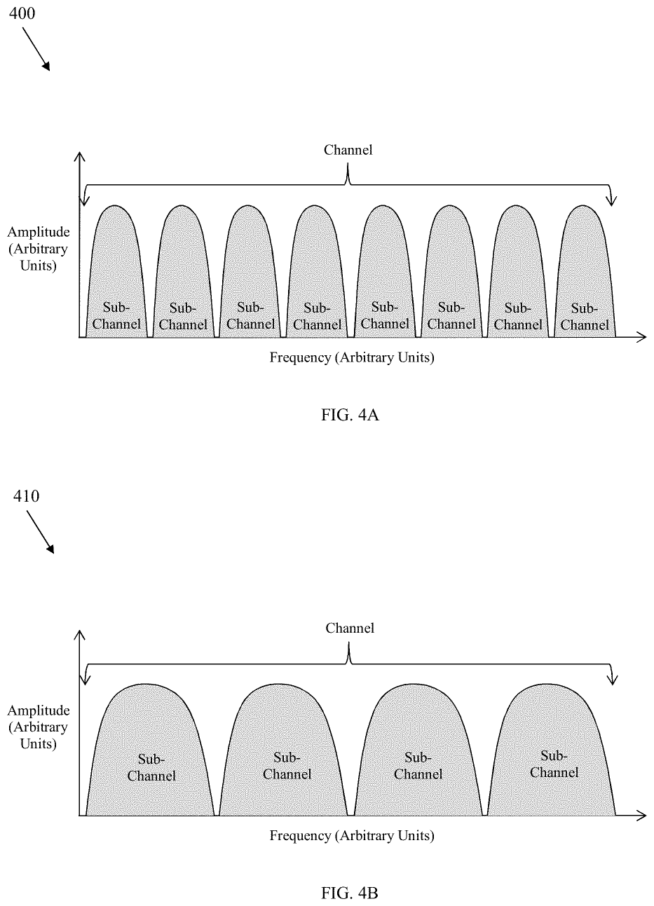

FIG. 4A is a graph of a channel scheme 400 according to an embodiment of the disclosure. The channel scheme 400 may apply to both the downstream optical signal and the upstream optical signal in FIGS. 2-3. The channel scheme 400 shows 8 sub-channels, which combine to form a single channel.

As a first example, for the downstream optical signal, each sub-channel has a bandwidth of 8 GHz and comprises a 6.25 GBd QPSK signal to provide a total data rate of 100 Gb/s since QPSK provides 2 bits per symbol. For the upstream optical signal, each sub-channel has a bandwidth of 8 GHz and comprises a 6.25 GBd NRZ signal to provide a total data rate of 50 Gb/s since NRZ provides 1 bit per symbol or comprises a 6.25 GBd PAM-4 signal to provide a total data rate of 100 Gb/s since PAM-4 provides 2 bits per symbol. The downstream optical signal and the upstream optical signal have a frequency spacing of 100 GHz.

As a second example, for the downstream optical signal, each sub-channel has a bandwidth of 8 GHz and comprises a 6.25 GBd QPSK signal to provide a total data rate of 100 Gb/s since QPSK provides 2 bits per symbol. In addition, the receivers 250, 350 implement intradyne detection. The receivers 250, 350 may therefore achieve an ADC sampling speed of about 14 GS/s or about 28 GS/s and an RF bandwidth of about 3.5 GHz or about 7 GHz.

As a third example, for the downstream optical signal, each sub-channel has a bandwidth of 8 GHz and comprises a 6.25 GBd 16-QAM signal to provide a total data rate of 200 Gb/s since 16-QAM provides 4 bits per symbol. In addition, the receivers 250, 350 implement intradyne detection. The receivers 250, 350 may therefore achieve an ADC sampling speed of about 14 GS/s or about 28 GS/s and an RF bandwidth of about 3.5 GHz or about 7 GHz.

As a fourth example, for the downstream optical signal, each sub-channel has a bandwidth of 8 GHz and comprises a 6.25 GBd PDM 16-QAM signal to provide a total data rate of 400 Gb/s since PDM 16-QAM provides 8 bits per symbol. In addition, the receivers 250, 350 implement PDM intradyne detection. The receivers 250, 350 may therefore achieve an ADC sampling speed of about 14 GS/s or about 28 GS/s and an RF bandwidth of about 3.5 GHz or about 7 GHz.

FIG. 4B is a graph of a channel scheme 410 according to another embodiment of the disclosure. The channel scheme 410 may apply to both the downstream optical signal and the upstream optical signal in FIGS. 2-3. The channel scheme 410 shows 4 sub-channels, which combine to form a single channel.

As a first example, for the downstream optical signal, each sub-channel has a bandwidth of 16 GHz and comprises a 12.5 GBd QPSK signal to provide a total data rate of 100 Gb/s since QPSK provides 2 bits per symbol. For the upstream optical signal, each sub-channel has a bandwidth of 16 GHz and comprises a 12.5 GBd NRZ signal to provide a total data rate of 50 Gb/s since NRZ provides 1 bit per symbol or comprises a 12.5 GBd PAM-4 signal to provide a total data rate of 100 Gb/s since PAM-4 provides 2 bits per symbol. The downstream optical signal and the upstream optical signal have a frequency spacing of 100 GHz.

As a second example, for the downstream optical signal, each sub-channel has a bandwidth of 16 GHz and comprises a 12.5 GBd QPSK signal to provide a total data rate of 100 Gb/s since QPSK provides 2 bits per symbol. In addition, the receivers 250, 350 implement intradyne detection. The receivers 250, 350 may therefore achieve an ADC sampling speed of about 14 GS/s or about 28 GS/s and an RF bandwidth of about 3.5 GHz or about 7 GHz.

As a third example, for the downstream optical signal, each sub-channel has a bandwidth of 16 GHz and comprises a 12.5 GBd 16-QAM signal to provide a total data rate of 200 Gb/s since 16-QAM provides 4 bits per symbol. In addition, the receivers 250, 350 implement intradyne detection. The receivers 250, 350 may therefore achieve an ADC sampling speed of about 14 GS/s or about 28 GS/s and an RF bandwidth of about 3.5 GHz or about 7 GHz.

As a fourth example, for the downstream optical signal, each sub-channel has a bandwidth of 16 GHz and comprises a 12.5 GBd PDM 16-QAM signal to provide a total data rate of 400 Gb/s since PDM 16-QAM provides 8 bits per symbol. In addition, the receivers 250, 350 implement PDM intradyne detection. The receivers 250, 350 may therefore achieve an ADC sampling speed of about 14 GS/s or about 28 GS/s and an RF bandwidth of about 3.5 GHz or about 7 GHz.

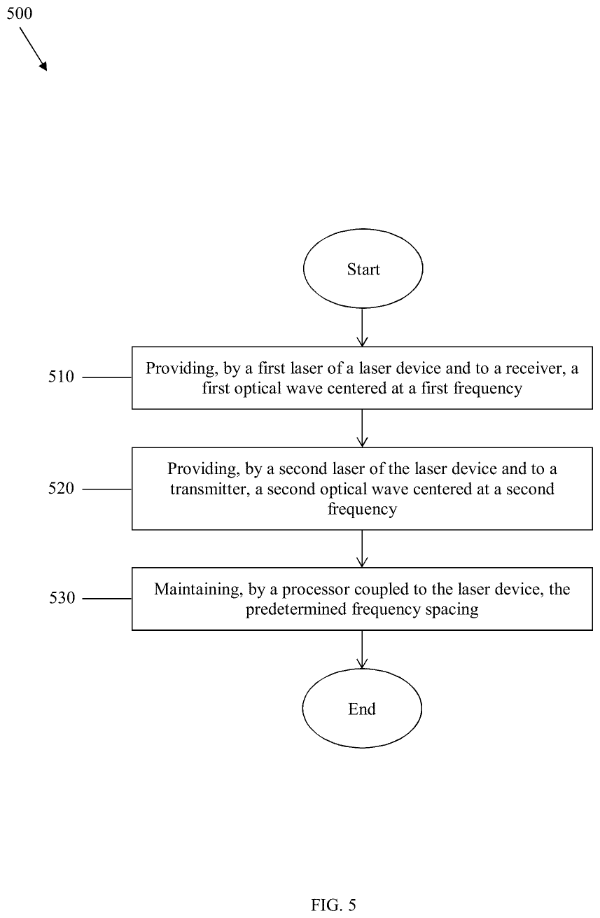

FIG. 5 is a flowchart illustrating a method 500 of implementing transceiving with a predetermined frequency spacing according to an embodiment of the disclosure. The ONU 200, 300 may implement the method. At step 510, a first optical wave centered at a first frequency is provided by a first laser of a laser device and to a receiver. For instance, the laser 220 provides the first optical wave to the receiver 250. At step 520, a second optical wave centered at a second frequency is provided by a second laser of the laser device and to a transmitter. For instance, the laser 240 provides the second optical wave to the transmitter 270. The first frequency and the second frequency have a predetermined frequency spacing. Finally, at step 530, the predetermined frequency spacing is maintained by a processor coupled to the laser device. For instance, the processor 260 provides a control signal to the controller 230, the controller 230 responds to the control signal by performing a control action, and the control action affects both the first laser and the second laser the same or substantially the same.

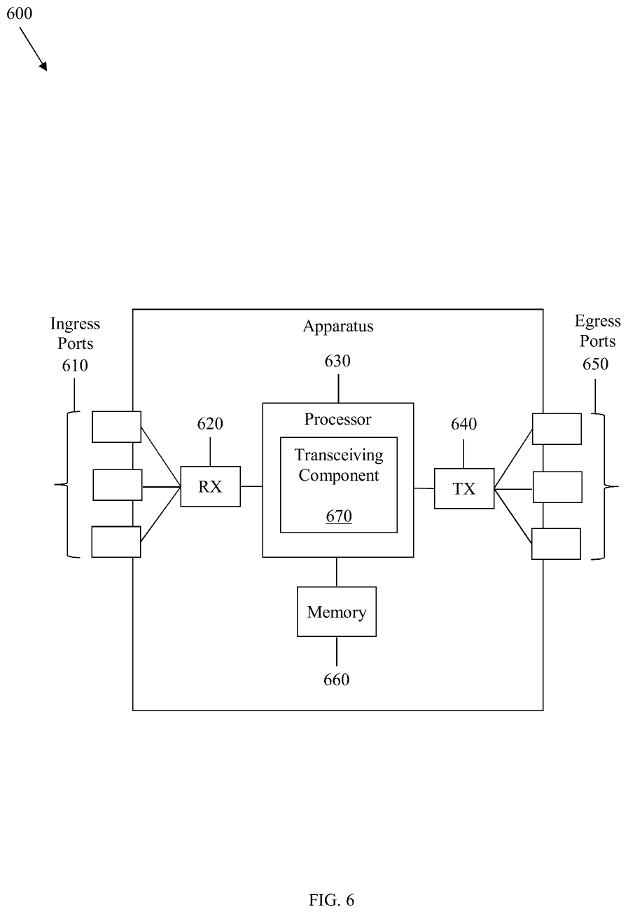

FIG. 6 is a schematic diagram of an apparatus 600 according to an embodiment of the disclosure. The apparatus 600 may implement the disclosed embodiments. The apparatus 600 comprises ingress ports 610 and an RX 620 coupled to the ingress ports 610 to receive data; a processor, logic unit, baseband unit, or CPU 630 coupled to the RX 620 to process the data; a TX 640 coupled to the processor 630 and egress ports 650 coupled to the TX 640 to transmit the data; and a memory 660 coupled to the processor 630 and configured to store the data. The apparatus 600 may also comprise OE components, EO components, or RF components coupled to the ingress ports 610, the RX 620, the TX 640, and the egress ports 650 to provide ingress or egress of optical signals, electrical signals, or RF signals.

The processor 630 is any combination of hardware, middleware, firmware, or software. The processor 630 comprises any combination of one or more CPU chips, cores, FPGAs, ASICs, or DSPs. The processor 630 communicates with the ingress ports 610, the RX 620, the TX 640, the egress ports 650, and the memory 660. The processor 630 comprises a transceiving component 670, which implements the disclosed embodiments. The inclusion of the transceiving component 670 therefore provides a substantial improvement to the functionality of the apparatus 600 and effects a transformation of the apparatus 600 to a different state. Alternatively, the memory 660 stores the transceiving component 670 as instructions, and the processor 630 executes those instructions.

The memory 660 comprises any combination of disks, tape drives, or solid-state drives. The apparatus 600 may use the memory 660 as an over-flow data storage device to store programs when the apparatus 600 selects those programs for execution and to store instructions and data that the apparatus 600 reads during execution of those programs. The memory 660 may be volatile or non-volatile and may be any combination of ROM, RAM, TCAM, or SRAM.

An apparatus comprises: a receiver element; a transmitter element; a laser element coupled to the receiver element and the transmitter element and comprising: a first laser element configured to provide to the receiver element a first optical wave centered at a first frequency, and a second laser element configured to provide to the transmitter element a second optical wave centered at a second frequency, the first frequency and the second frequency have a predetermined frequency spacing; and a processor element coupled to the receiver element, the transmitter element, and the laser element and configured to control the first laser and the second laser to maintain the predetermined frequency spacing.

In an example embodiment, the apparatus 600 includes a first optical wave module providing to a receiver a first optical wave centered at a first frequency, a second optical wave module providing to a transmitter a second optical wave centered at a second frequency, the first frequency and the second frequency have a predetermined frequency spacing, and a spacing module maintaining the predetermined frequency spacing. In some embodiments, the apparatus 600 may include other or additional modules for performing any one of or combination of steps described in the embodiments. Further, any of the additional or alternative embodiments or aspects of the method, as shown in any of the figures or recited in any of the claims, are also contemplated to include similar modules.

The term “about” means a range including ±10% of the subsequent number unless otherwise stated. The term “substantially” means within ±10%. While several embodiments have been provided in the present disclosure, it may be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, components, techniques, or methods without departing from the scope of the present disclosure. Other items shown or discussed as coupled may be directly coupled or may be indirectly coupled or communicating through some interface, device, or intermediate component whether electrically, mechanically, or otherwise. Other examples of changes, substitutions, and alterations are ascertainable by one skilled in the art and may be made without departing from the spirit and scope disclosed herein.

What is claimed is:

1. An apparatus comprising:
a receiver;
a transmitter;
a laser device coupled to the receiver and the transmitter and comprising:
a first laser configured to provide to the receiver a first optical wave centered at a first frequency, and
a second laser configured to provide to the transmitter a second optical wave centered at a second frequency, the first frequency and the second frequency have a predetermined frequency spacing; and
a processor coupled to the receiver, the transmitter, and the laser device and configured to control the first laser and the second laser to maintain the predetermined frequency spacing.

2. The apparatus of claim 1, wherein the first laser is a local oscillator (LO), and wherein the first optical wave is an LO wave, and wherein the receiver is a coherent optical receiver configured to:
receive a downstream optical signal centered at a third frequency;
receive the LO wave from the first laser;
determine a frequency offset between the first frequency and the third frequency; and
provide to the processor a feedback signal based on the frequency offset.

3. The apparatus of claim 1, wherein the second laser is a carrier laser, and wherein the second optical wave is a carrier wave, and wherein the transmitter is configured to:
receive the carrier wave from the second laser;
receive a data signal from the processor;
modulate the carrier wave using the data signal to create an upstream optical signal; and
provide the upstream optical signal.

4. The apparatus of claim 3, wherein the transmitter is further configured to further modulate the carrier wave using on-off keying (OOK) modulation or pulse-amplitude modulation (PAM).

5. The apparatus of claim 1, further comprising:
a splitter coupled to the receiver and the transmitter and configured to:
provide a downstream optical signal to the receiver, and
receive an upstream optical signal from the transmitter; and
a port coupled to the splitter and configured to:
receive the downstream optical signal from a second apparatus over an optical fiber,
provide the downstream optical signal to the splitter,
receive the upstream optical signal from the splitter, and
transmit the upstream optical signal towards the second apparatus over the optical fiber.

6. The apparatus of claim 5, wherein the port is further configured to provide bidirectional communication over the optical fiber, and wherein the port is the only communications port in the apparatus.

7. The apparatus of claim 1, wherein the laser device further comprises a controller coupled to the processor and configured to:
receive a control signal from the processor; and
perform a control action on both the first laser and the second laser in response to the control signal,
wherein the controller is a heater and the control action is heating, the controller is a thermoelectric cooler (TEC) and the control action is cooling, or the controller is a bias current controller and the control action is a bias current.

8. The apparatus of claim 1, wherein the predetermined frequency spacing is set by a design of the laser device, wherein the processor is further configured to further maintain the predetermined frequency spacing independent of an ambient temperature, and wherein the predetermined frequency spacing is about 100 gigahertz (GHz).

9. The apparatus of claim 1, wherein the apparatus is an optical network unit (ONU) in a point-to-multipoint (PTMP) network.

10. A method comprising:
providing, by a first laser of a laser device and to a receiver, a first optical wave centered at a first frequency;
providing, by a second laser of the laser device and to a transmitter, a second optical wave centered at a second frequency, the first frequency and the second frequency have a predetermined frequency spacing; and
maintaining, by a processor coupled to the laser device, the predetermined frequency spacing.

11. The method of claim 10, further comprising:
receiving a downstream optical signal centered at a third frequency;
determining a frequency offset between the first frequency and the third frequency; and
providing to the processor a feedback signal based on the frequency offset.

12. The method of claim 10, wherein the second optical wave is a carrier wave, and wherein the method further comprises:
receiving a data signal from the processor; and
modulating the carrier wave using the data signal to create an upstream optical signal.

13. The method of claim 10, further comprising:
receiving a control signal from the processor; and
performing a control action on both the first laser and the second laser in response to the control signal.

14. The method of claim 13, wherein the control action is heating, cooling, or a bias current.

15. The method of claim 10, further comprising further maintaining the predetermined frequency spacing independent of an ambient temperature.

16. An optical network unit (ONU) comprising:
a receiver;
a laser device coupled to the receiver and comprising:
a first laser configured to provide to the receiver a first optical wave centered at a first frequency, and
a second laser configured to provide an upstream optical signal centered at a second frequency, the first frequency and the second frequency have a predetermined frequency spacing, and the second laser is a directly-modulated laser (DML); and
a processor coupled to the receiver and the laser device and configured to control the first laser and the second laser to maintain the predetermined frequency spacing.

17. The ONU of claim 16, wherein the first laser is a local oscillator (LO), wherein the first optical wave is an LO wave, and wherein the receiver is configured to:
receive a downstream optical signal centered at a third frequency;
receive the LO wave from the first laser;
determine a frequency offset between the first frequency and the third frequency; and
provide to the processor a feedback signal based on the frequency offset.

18. The ONU of any of claim 16, further comprising a splitter coupled to the receiver and the second laser and configured to:
provide a downstream optical signal to the receiver; and
receive the upstream optical signal from the second laser.

19. The ONU of claim 18, further comprising a port coupled to the splitter and configured to:
receive the downstream optical signal from an optical line terminal (OLT) over an optical fiber,
provide the downstream optical signal to the splitter,
receive the upstream optical signal from the splitter, and
transmit the upstream optical signal towards the OLT over the optical fiber.

20. The ONU of claim 16, wherein the laser device further comprises a controller coupled to the processor and configured to:
receive a control signal from the processor; and
perform a control action on both the first laser and the second laser in response to the control signal.
